(19) United States
(12) Patent Application Publication
(10) Pub. No.: US 2009/0243964 A1
(43) Pub. Date: Oct. 1, 2009

(54) DISPLAY APPARATUS

(75) Inventors: Birgit Rottenkolber, Koesching (DE); Klaus Beck, Singapore (SG); Christian Knoop, Zurich (DE); Nathaniel A. Jarvis, Herrenberg (DE); Peter Weber, Altensteig (DE); Bertold Engler, Altensteig (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: CARL ZEISS AG, Oberkochen (DE)

(21) Appl. No.: 12/260,597

(22) Filed: Oct. 29, 2008

(30) Foreign Application Priority Data
Oct. 29, 2007 (DE) 102007051959.3

(51) Int. Cl. G09G 5/00

(52) U.S. Cl. 345/8

(57) ABSTRACT

A display apparatus which comprises an image module for generating an image, a spectacle-like frame which carries the image module, and wherein the spectacle-like frame comprises a front portion with a nose support, as well as two side arms mounted to the front portion. At least one earphone is mounted to the frame via a positioning mechanism. The earphone can be positioned in front of an ear of a user by means of the positioning mechanism, when the display apparatus is mounted on the user's head. The positioning mechanism comprises a linear guide which is mounted to the frame via a hinge joint and the earphone is positioned at the end of the linear guide, turned away from the hinge joint.

### PRIORITY APPLICATION

The current application claims the benefit of priority to German Patent Application No. DE 10 2007 051 959.3 filed on Oct. 29, 2007. Said application is incorporated in its entirety by reference herein.

### FIELD OF DISCLOSURE

The present invention relates generally to the field of display apparatuses. Such apparatuses are often referred to as HMD apparatuses (Read-Mounted Display apparatuses). More specifically, the present invention relates to a display apparatus comprising an image module for generating an image, and a spectacle-like frame which carries the image module and has a front portion with a nose support, as well as two side arms (lateral temples), mounted to the front portion. At least one earphone is mounted to the frame via a positioning mechanism, which earphone can be positioned in front of an ear of the user by means of the positioning mechanism when the display apparatus is mounted on the user's head.

### BACKGROUND OF THE INVENTION

A display apparatus comprising an earphone is disclosed, for example, in US Patent Application No. 2005/0168824 A1. In this display apparatus, however, the positioning mechanism for the earphone is provided as a flexible tube to enable insertion of the earphone into the auditory canal of a user's ear. Such a positioning mechanism is suitable only for earphones which are to be inserted into the auditory canal (inear headphones), because secure positioning of the earphone is substantially ensured by inserting the earphone into the car canal. A positioning mechanism in the shape of a flexible tube is not suitable for an earphone to be placed in external contact with the ear, because such a positioning mechanism cannot ensure an adjusted position permanently. Even minor forces are sufficient to change the position, thus undesirably causing deteriorated perception, or no perception at all, of the acoustic signals from the earphone by the user.

The earphones of the display apparatus spectacles provided with earphones disclosed in DE 196 24 184 A1 are also mounted to the spectacles via flexible tubes. Thus, there is the problem again that permanent positioning at the user's ear cannot be ensured.

U.S. Pat. No. 7,147,324 B2 also describes display apparatus spectacles including earphones. The earphones each comprise a connecting piece in the form of a hollow cylinder which is guided on a linearly extending rod. Thus, linear displacement and, at the same time, rotation about the longitudinal axis of the rod are possible. However, this configuration results in the disadvantage that positioning on the ear is very difficult to ensure because even minor forces are sufficient to cause rotation about the longitudinal axis of the rod. Since the longitudinal axis of the rod runs parallel to the side arm of the spectacles, this causes the ear phones to be lifted up from the ear.

JP 7-159720 discloses a display apparatus including a head ring or a head band, respectively, for mounting the apparatus on the head. Such a display apparatus exhibits little wearing comfort and is difficult to mount and to wear.

In view thereof, there is a need for an improved display apparatus such that the earphone is easy to position on the ear of the respective user and that such positioning can be permanently 20 maintained until the user decides to shift the position of the earphone.

### SUMMARY OF THE INVENTION

In one embodiment of the invention, a display apparatus includes a positioning mechanism which comprises a linear guide, which is mounted to the frame via a hinge joint, and the earphone is arranged at the end of the linear guide turned away from the hinge joint, such that the earphone faces the user's head. This design of the positioning mechanism allows individually adapted positioning of the earphone at the user's ear (and not in his ear) and keeping the earphone in that position. Further, the display apparatus can have a very compact design while also being very comfortable to wear.

The positioning mechanism can further include a locking mechanism by which the adjusted position of the earphone can be locked. In particular, the locking mechanism can enable separate locking or fixing, respectively, of the hinge joint and of the linear guide. Locking is facilitated, for example, by means of friction locking and/or positive locking (form fit locking).

Further, the linear guide can be provided as a telescopic guide. Use of a telescopic guide provides the advantage that the telescopic guide requires little space when pushed together. The positioning mechanism can elastically pretension the earphone in a direction transverse to the linear guide. This elastic pretension ensures that the earphone contacts the ear even with the different head sizes of the different users. In particular, elastic pretension can be provided by the inherent elasticity of the linear guide. The linear guide can comprise an arresting mechanism, by which different linear positions of the linear guide can be set. The different linear positions of the linear guide can also be set by means of a clamping element.

Further, the hinge joint can be provided such that it can be arrested in various rotary positions. In particular, the hinge joint of the positioning mechanism can be mounted to one of the side arms. This positioning results in a particularly space-saving design of the display apparatus. Further, each side arm of the display apparatus can comprise a positioning mechanism, each positioning mechanism having an earphone. This configuration allows the application of sound to both ears of the user. The two earphones can be optimally positioned independently of each other relative to the respective ear. In particular, the earphones can have a directional characteristic in the direction of the ears, for example, when the display apparatus is mounted on the head.

The image module for generating the image can generate the image as a virtual image such that a user can perceive it at a predetermined distance in front of the eye. The display apparatus according to the invention can also be referred to as an HMD apparatus (Head-Mounted Display apparatus). In particular, the image module can have a similar design as in known HMD apparatuses. Further, the image module can comprise a control device which controls an image-generating element of the image module on the basis of predetermined image data such that the desired image is generated. The image module can further comprise imaging optics for imaging the image generated by means of the image-generating element. The control device of the image module can also be used to control the earphones.

It will be appreciated that the aforementioned features and those yet to be explained below can be used not only in the indicated combinations, but also in other combinations or alone, without departing from the scope of the present invention.

### BRIEF DESCRIPTION OF THE DRAWINGS

These as well as other objects and advantages of this invention will be more completely understood and appreciated by referring to the following more detailed description of the exemplary embodiments of the invention in conjunction with the accompanying drawings. The invention will be explained in more detail below, by way of example and with reference to the enclosed drawings, which also disclose features essential to the invention and wherein:

FIG. 1 shows a lateral view of a first embodiment of the display apparatus according to the invention;

FIG. 2 shows a perspective view of the display apparatus of FIG. 1;

FIG. 3 shows a greatly simplified top view showing the image module of the display apparatus of FIG. 1;

FIG. 4 shows a perspective view of the display apparatus of FIG. 1, depicting the left side arm of the spectacles in an exploded view;

FIG. 5 shows a sectional view of the positioning mechanism;

FIG. 6 shows a sectional view of the hinge joint of the positioning mechanism;

FIG. 7 shows a lateral view of the left side arm together with the positioning mechanism, showing an embodiment of the display apparatus according to the invention; and

FIG. 8 shows a lateral view of the left side arm together with the positioning mechanism, with the cover of the housing removed.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives.

### DETAILED DESCRIPTION OF EMBODIMENTS OF THE INVENTION

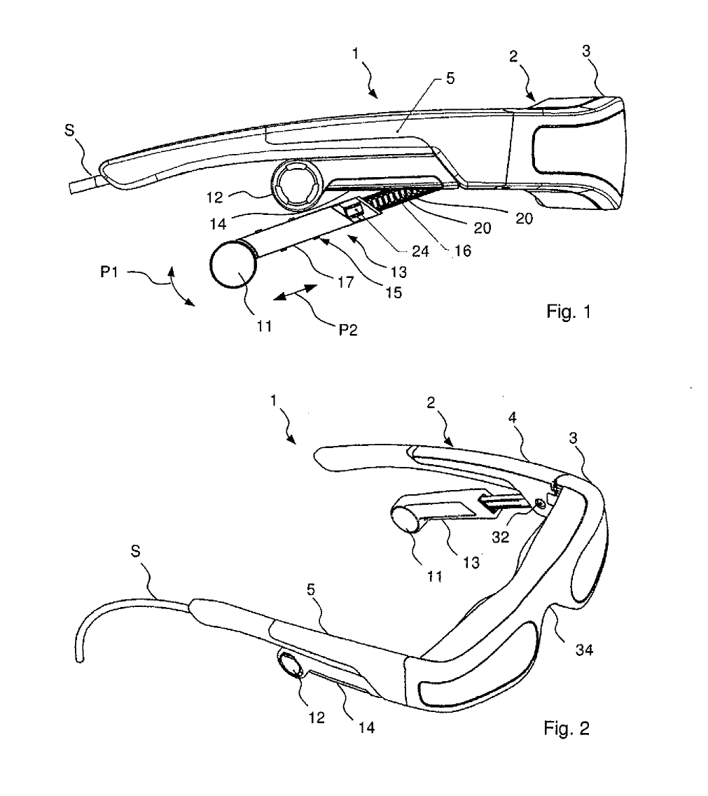

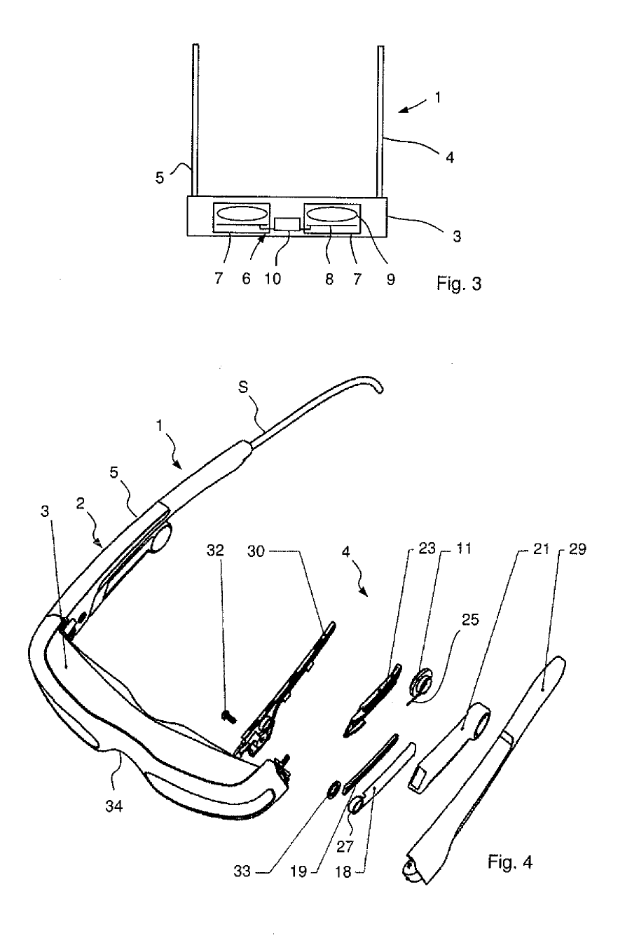

In the embodiment shown in FIGS. 1 to 6, the display apparatus 1 comprises a spectacle-like frame 2 including a front portion 3 and two side arms 4, 5. As is evident from the schematic representation in FIG. 3, the front portion 3 includes an image module 6 which comprises, for each eye of a user wearing the display apparatus 1, a display unit 7 with an image-generating element 8 and imaging optics 9. The image module 6 further comprises a control unit 10, which controls the display units 7 on the basis of predetermined image data so as to generate the desired images. The image data can be supplied to the control unit 10, for example via the signal line 1 extending through the right side arm 5.

One earphone 11, 12 each is mounted to each side arm 4, 5 via a positioning mechanism 13, 14. Since the earphones 11, 12 and their assigned positioning mechanisms 13, 14 are designed to have mirror symmetry relative to each other, only the positioning mechanism 13 comprising the earphone 11 for the left side arm 4 will be described in detail below. It is noted that the right side arm 5 additionally comprises the signal line 1.

As is most clearly evident from FIGS. 1 and 2, the positioning mechanism 13 is designed such that the earphone 11 can be pivoted downwards relative to the side arm 4 (arrow P1 in FIG. 1) and is displaceable in the longitudinal direction (arrow P2 in FIG. 1) of the positioning mechanism 13. For this purpose, the positioning mechanism 13 comprises a linear telescopic guide 15 which is rotatably mounted to the side arm 4. The linear telescopic guide 15 comprises a first telescopic unit 16 and a second telescopic unit 17, the second telescopic unit 17 being displaceable in a longitudinal direction relative to the first telescopic unit 16. The first telescopic unit 16 comprises a telescopic guide 18 (FIG. 4), which is rotatably mounted to the side arm 4, as well as an arresting plate 19, which is mounted to the telescopic guide 18 and comprises several spaced-apart grooves 20 in a longitudinal direction thereof (FIG. 1).

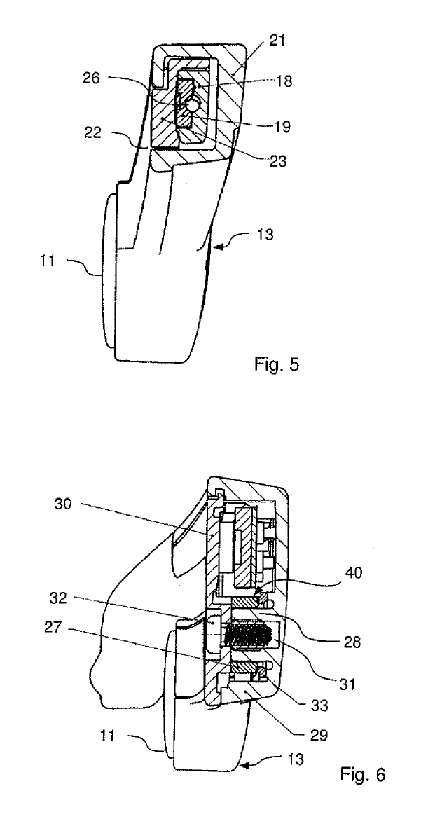

The second telescopic unit 17 comprises a telescope housing 21 (FIGS. 4, 5), whose inwardly directed lateral opening 22 is closed by a telescope cover 23. The telescope cover 23 comprises an arresting element 24 (FIG. 1) which, when the telescope housing is slid onto the telescopic guide 18, engages in one of the grooves 20 of the arresting plate 19. The arresting element 24 is designed to be elastic so as to be pretensioned against the arresting plate 19 and, thus, a predetermined force has to be applied in order to displace the second telescopic unit 17 linearly relative to the first telescopic unit 16. After displacement has been effected, the arresting element 24 then engages in the corresponding groove 20 and, thus, fixes placement of the second telescopic unit 16.

The telescope housing 21 is provided, at its rear end, with a receiving part for the earphone 11, the earphone 11 being inserted into the receiving part. The connection cable 25 of the earphone 11 extends through a corresponding through hole 26 (FIG. 5) in the first telescopic unit 16. The connection cable 25 is shown only in FIG. 4. The through hole 26 is limited here by the telescopic guide 18 and the arresting plate 19. The connection cable 25, which passes through the through hole 26, extends as far as the control unit 10 in the front portion 3, so that the control unit 10 can also control the earphone 11 so as to present audio signals to the user of the display apparatus 1. The audio signals can be, in particular, acoustic signals, texts and/or music. The connection cable 25 is provided such that length compensation, that is, length adjustment, is effected when the length of the telescopic guide 18 is changed. The varied length of the connection cable 25 can be accomplished, for example, by having at least one spiral-shaped cable portion or a cable drum with pretension.

As is most clearly evident from FIGS. 4 and 6, the front end 27 of the telescopic guide 18 has an annular shape and is rotatably mounted on an axial portion 28 of a housing 29 of the side arm 4, the housing 29 being closed from the inside by a housing cover 30 which, at the same time, secures the front end 27 of the telescopic guide 18 in an axial direction. For this purpose, the axial portion 28 comprises a central bore 31 into which a fixing screw 32 is screwed through the housing cover 30. Further, a circlip 33 is arranged inside the housing 29, the circlip 33 pressing the front end 27 of the telescopic guide 18 against the housing cover 30 such that the inherent weight of the linear telescopic guide 15, together with the earphone 11, causes no change in the rotary position due to the existing friction lock. A further external force has to be applied in order to change the rotary position. Together with the axial portion 18, the front end 27 of the telescopic guide 18 forms a hinge joint 40.

Thus, the positioning mechanism 13 allows pivoting of the earphone 11 relative to the side arm 4 (hinge joint 40) and the linear telescopic guide 15 allows changing of the distance of the earphone 11 from the axis of rotation of the positioning mechanism 13 or from the hinge joint 40, respectively. This arrangement enables positioning of the earphone 11 in two degrees of freedom.

When a user is wearing the display apparatus 1, both side arms 4 and 5 are supported on the user's ears and a nose support 34 of the front portion 3 is supported on the bridge of the user's nose. Thus, the user wears the display apparatus 1 in the manner of spectacles and can position the ear phones 11 and 12 exactly in front of his ears (in front of the outer auditory canal) due to the degrees of freedom provided by the positioning mechanisms 13, 14. Further, the linear telescopic guide 15 is designed such that it is pretensioned inwardly (i.e. towards the opposite side arm 5) due to its inherent elasticity, which allows for compensation for different widths of users' heads, while ensuring that the earphone 11 is supported on the user's ear or on the auricle in front of the outer auditory canal.

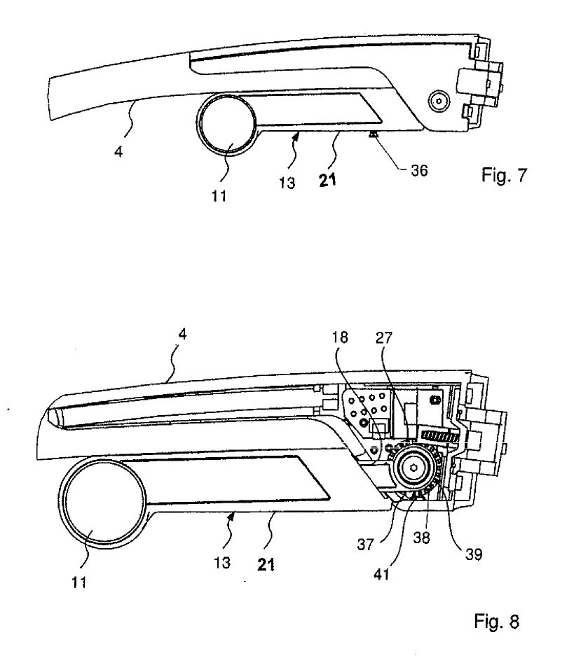

FIG. 7 shows a lateral view of the side arm 4 together with the positioning mechanism 13 and the earphone 11, wherein the positioning mechanism 13 differs from the previously described embodiment in the manner of fixation of the mutually displaceable telescopic units 16 and 17. As indicated in FIG. 7, a fixing screw 36 is screwed into the telescope housing 21 from below. Tightening the fixing screw 36 enables the second telescopic unit 17 to press against the first telescopic unit 16 from inside, thereby producing a friction lock so as to achieve the desired fixing or mating of the two telescopic units 16 and 17. In this case, the fixing screw 36 can be tightened such that a friction lock is present, which, however, allows displacement of the two telescopic units 16 and 17 relative to each other by pulling or pushing the earphone 11 in the longitudinal direction of the linear telescopic guide 15. However, if no external force is applied, both telescopic units 16 and 17 are fixed with respect to each other.

FIG. 8 shows a modification of the hinge joint 40. In this case, an axially extending projection 37 is formed at the front end 27 of the telescopic guide 18. As a counterpart to the projection 37, an arresting ring 38 is arranged in the housing 29 in a manner secured against rotation, the arresting ring 38 comprising a multiplicity of spaced-apart grooves 39 in a circumferential direction. Due to the grooves 39, various pivoting positions of the positioning mechanism 13 are predetermined, in which the projection 37 extends into the respective groove 39 and, thus, causes locking in the respective pivoting position. Further, a stop element 41 can be provided in the housing 29, against which stop element 41 the projection 37 abuts in the “parking position” (shown in FIG. 8) of the positioning mechanism 13 so as to fix the positioning mechanism 13 in this position. Further, the telescopic guide 18 can also be fixed in such a position by being arrested in the position in which the telescopic guide 18 is pushed together to the maximum possible extent.

In another embodiment, the arresting ring 38 can be provided at the front end 27 of the telescopic guide 18 and the projection 37 can be connected with the housing 29.

Further, the pivoting position can be secured by clamping. Also, a fixing element in the form of a gooseneck can also be used, so as to arrest the adjusted pivoting position.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents.

We claim:

1. A display apparatus, comprising:
a frame comprising a front portion including a nose support, and two side arms operably mounted to the front portion;
an image module for generating an image, the image module operably coupled to the front portion of the frame; and
a positioning mechanism comprising a linear guide and an earphone, wherein a first end of the linear guide is operably coupled to the frame via a hinge joint, and the earphone is operably coupled to a second end of the linear guide and turned away from the hinge joint, and wherein the earphone is positionable in front of a user's ear when the display apparatus is mounted on the user's head.

2. The display apparatus of claim 1, further comprising a locking mechanism adapted to lock the position of the positioning mechanism and the adjusted position of the earphone.

3. The display apparatus of claim 2, the locking mechanism enabling independent locking of the hinge joint and of the linear guide.

4. The display apparatus of claim 2, wherein locking is effected by at least one of friction locking and fining locking.

5. The display apparatus of claim 2, wherein at least one of the side arms comprises a housing and the locking mechanism is operably positioned in the housing.

6. The display apparatus of claim 1, wherein the linear guide comprises an arresting mechanism.

7. The display apparatus of claim 1, wherein the earphone is elastically pretensionable by the positioning mechanism in a direction transverse to the linear guide.

8. The display apparatus of claim 7, wherein the elastic pretension is provided by the inherent elasticity of the linear guide.

9. The display apparatus of claim 1, wherein the hinge joint is operably arrestable in one of a plurality of rotary positions.

10. The display apparatus of claim 1, wherein the linear guide further comprises a clamping element, wherein the clamping element maintains an adjusted linear position of the linear guide.

11. The display apparatus of claim 1, wherein the hinge joint of the positioning mechanism is mounted to one of the side arms.

12. The display apparatus as of claim 1, wherein one positioning mechanism is mounted to each side arm, each positioning mechanism including an earphone.
